(19) United States
(12) Patent Application Publication
(10) Pub. No.: US 2008/0089505 A1
(43) Pub. Date: Apr. 17, 2008

(54) Method for Allocating a Characteristic for Allowing a Terminating Automatic Return Call

(75) Inventor: Peter Goldstein, Thalwil (CH)

Correspondence Address: SIEMENS SCHWEIZ AG;I-47, INTELLECTUAL PROPERTY, ALBISRIEDERSTRASSE 245, ZURICH, CH-8047, CH

(73) Assignee: SIEMENS SCHWEIZ AG, ZURICH SWITZERLAND (CH)

(21) Appl. No.: 11/666,004

(22) PCT Filed: May 17, 2005
(86) PCT No.: PCT/EP05/05330

§ 371 Date: Apr. 20, 2007

(30) Foreign Application Priority Data
Oct. 26, 2004 (EP) 04025373.4

(51) Int. Cl. H04M 3/42

(52) U.S. Cl. 379/210.01

(57) ABSTRACT

In a method for allocating a characteristic for allowing a terminating automatic return call from an A subscriber to a B subscriber, which are each connected to a switching office, the B subscriber is dialed via an IN service having number conversion, and the IN service is provided by means of a Service Switching Point and a Service Control Point. The switching office provides for the B-subscriber an indicator at an individual level that contains information as to whether an automatic return call is allowed for the B-subscriber. An image of the indicator is transmitted to the switching office of the A-subscriber in a connection set-up/release message. Depending on information transmitted by the Service Control Point, the permission contained in the indicator for an automatic return call is modified in the image in the Service Switching Point.

### BACKGROUND OF THE INVENTION

The present invention relates to a method for allocating a characteristic for allowing a terminating automatic return call.

Hereafter, instead of using non-specialized German terminology, the English nomenclature and acronyms from the ITU-T and ETSI standards are used, such as, for example:
“IN” “Intelligent Network”,
“SCP” “Service Control Point”,
“CCBS/CCNR” “Call completion busy subscriber”/“Call completion no reply”. The use of standardized terms and acronyms avoids any lack of clarity. A list of acronyms, abbreviations and terms used at the end of this document forms an integral part of this document.

The present invention relates to the field of end-to-end additional services such as, for example, automatic return call “call completion”. The automatic return call “call completion” service for connections from an A subscriber (caller) to a B subscriber (callee) is specified by the following terms CCBS and CCNR in ITU-T I.253.3 (07-1996), Completion of calls to busy subscribers, and ITU-T I.253.4 (07-1996), Completion of calls on no reply, respectively:
Call completion busy subscriber (CCBS);
Call completion no reply (CCNR).

At the A-subscriber end, it is established according to ITU-T I.253.3 (07-1996), Completion of calls to busy subscribers, that the CCBS service can be assigned to the A-subscriber at an individual level, for this see in ITU-T I.253.3 (07-1996), Completion of calls to busy subscribers, “3.1 provision/withdrawal”, first paragraph.

At the B-subscriber end, there is both in general and in particular for those subscribers who are connected to an automatic subscriber exchange—also known as a branch exchange—no standardized individual allocation according to ITU-T or ETSI as to whether the automatic return call service may be activated for said B-subscribers. The reason for this is that the necessity for differentiation at the subscriber level has not been recognized. Therefore the information as to whether the activation of an automatic return call is allowed is derived for each distribution point from the presence or absence of functionality in the distribution point.

This distribution point-specific establishment of permission without taking the type of subscriber into account has proved to be inadequate. This also applies to connections which contain a number conversion, as is the case with IN connections, and where the SCP (valid from IN capability set 2) decides, on the basis of the relevant IN service without taking the type of subscriber into account, whether the call completion indicator provided by the B-subscriber's distribution point should be overwritten with the content “possible” or, if necessary, with the content “not possible”. This indicator or the image thereof is contained in the “RELEASE” message for connection release, originating from the B-subscriber's distribution point. Thus, for example, with IN connections having the numerical sequence 0900 . . . , the “call completion” indicator CCI is reset from “possible” to “not possible”. This additionally makes it possible to prevent IN-specific billing from being circumvented by an automatic return call. In certain IN services, such as, for example, “Corporate Access” (virtual, geographically independent direct dialing-in zone for businesses), this modification of the indicator is not sufficient on the basis of the IN service alone, however, since a distinction ought to be made here between the telephone number of the switchboard and the telephone numbers of individual employees in a business. “Corporate Access” businesses with geographically scattered locations use Corporate Access so that they can be reached on one telephone number (irrespective of the location), and can take into account geographical (nearest business location) and temporal criteria (business location where the switchboard is staffed in the relevant period, allowing for regional public holidays, for example).

The establishment of permission for an automatic return call through the distribution point is also inadequate because the network operator receives malfunction reports as a result of the restricted availability of this additional service, the reports being due not to a malfunction but to a limited functionality.

EN 301 140 V1.3.4 (199-06), Intelligent Network (IN), Intelligent Network Application Protocol (INAP, Capability Set 2 (CS2), Part 1: Protocol specification, ETSI, 1999, discloses how, through the IN service, but not at individual subscriber level, the SCP can instruct the SSP to modify the “call completion” indicator in the “RELEASE” message if necessary.

### SUMMARY OF THE INVENTION

The object underlying the present invention is thus to specify a method for allocating a characteristic for allowing a terminating automatic return call that can be specifically administered by or for the B-subscriber. In particular, this method is also intended to allow the provision of the relevant information in the “call completion” indicator (only) to B-subscribers who can be addressed via an IN service.

Accordingly, one aspect involves a method for allocating a characteristic for allowing a terminating automatic return call from an A subscriber to a B subscriber, which are each connected to a switching office. The B subscriber is dialed via an IN service having number conversion, and the IN service is provided by means of a Service Switching Point and a Service Control Point. The switching office provides for the B-subscriber an indicator at an individual level that contains information as to whether an automatic return call is allowed for the B-subscriber. An image of the indicator is transmitted to the switching office of the A-subscriber in a connection set-up/release message. Depending on information transmitted by the Service Control Point, the permission contained in the indicator for an automatic return call is modified in the image in the Service Switching Point.

The process steps according to the invention provide a method that does not require adaptations of any kind in the respective telecommunications network or therefore on further distribution points apart from that of the B-subscriber, and thus conforms to the existing ITU-T and ETSI recommendations and standards. The term “terminating automatic return call” is used because, according to the present invention, permission for the automatic return call “call completion” service is divided up into a permission for activation component and a permission to answer automatic return calls component, the latter being related not to the distribution point assigned to the B-subscriber but to the respective B-subscriber.

To put the exact facts of the case once again in another way: the method according to the invention relates to the allocation of permission to be called by an automatic return call and not, for instance, to permission to activate an automatic return call. In order to facilitate allocation at individual B-subscriber level of permission for an automatic return call, the invention arranges for said allocation to be based on an individual indicator that is specific to each B-subscriber. In one embodiment of the present invention this can be implemented, for example, by using a single bit for each B-subscriber. This bit contains the information:
“CCBS/CCNR possible”
Automatic return call allowed, code 1:
   or
“CCBS/CCNR not possible”
Automatic return call not allowed, code 0:

Advantageous embodiments of the invention are set out in further claims.

### BRIEF DESCRIPTION OF THE SEVERAL VIEWS OF THE DRAWINGS

Exemplary embodiments of the invention are explained hereafter with the aid of the drawings, in which;

FIG. 1 shows a configuration for the IN “Corporate Access” service using Centrex;

FIG. 2 shows a configuration for the IN “Corporate Access” service using private branch exchanges; and

FIG. 3 shows a message procedure for applying the CC indicator CCI.

### DETAILED DESCRIPTION OF THE INVENTION

The following exemplary embodiments disclose preferred embodiments having allocation at individual B-subscriber level of permission for an automatic return call.

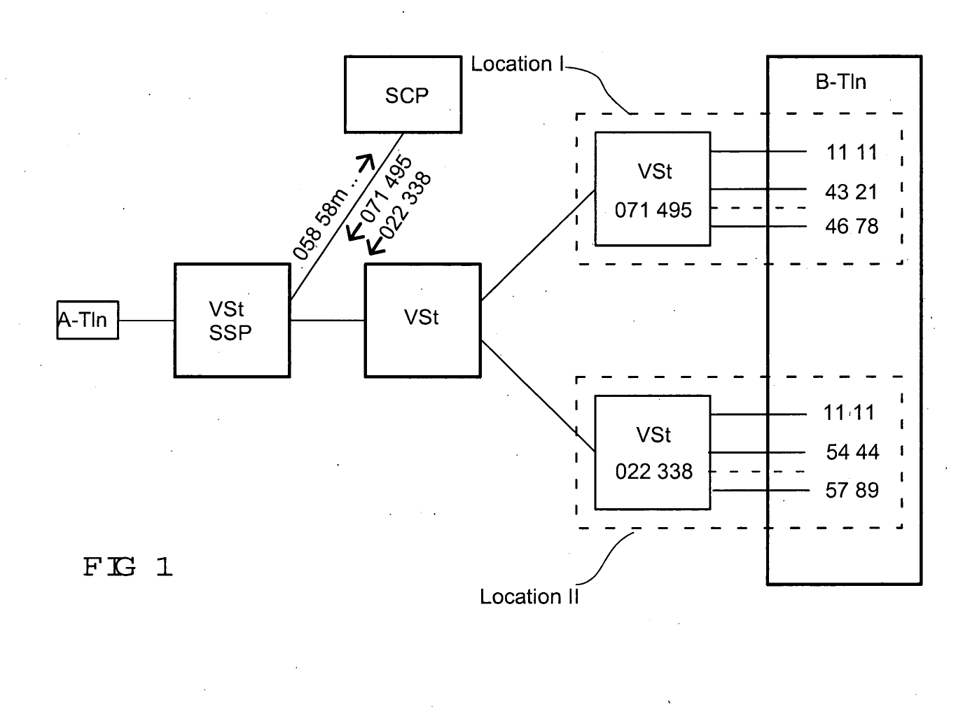

In a first configuration according to FIG. 1, the invention is explained for a group of B-subscribers B-Tln who are connected to a telecommunications network by the Centrex service. It is assumed here that these Centrex B-subscribers B-Tln are connected to different distribution points VSt, the various distribution points VSt being geographically in different locations. This is shown in FIG. 1 by the reference signs location I and location II. In this embodiment, it is assumed that there is a closed-end numbering plan. The type of numbering plan and the numbering plan itself have no significance for the implementation of the invention, however. A business has a plurality-of B-subscribers who are shown in the figure by geographical telephone numbers. In one location, location I, addressing is achieved using the geographical telephone number 071 495 nn nn, which is not visible to any A-subscriber outside the Centrex group for this business. In another location, location II, subscribers in the same company are characterized by geographical numbers 022 338 mm mm. In accordance with the Centrex functionality that is implemented in a plurality of distribution points VSt, subscribers may be addressed among themselves using, for example, four-digit internal numbers. External calls are achieved via the IN “Corporate Access” service, using 058 585 nn nn in the present example. In the Signaling Control Point SCP, the number dialed is converted as a function of the number dialed. Said conversion can be configured, for example, to be dependent on the telephone number of the A-subscriber and/or of the time of day. For this purpose, the SCP generally uses a data structure in the form of a table that contains the aforementioned conditions.

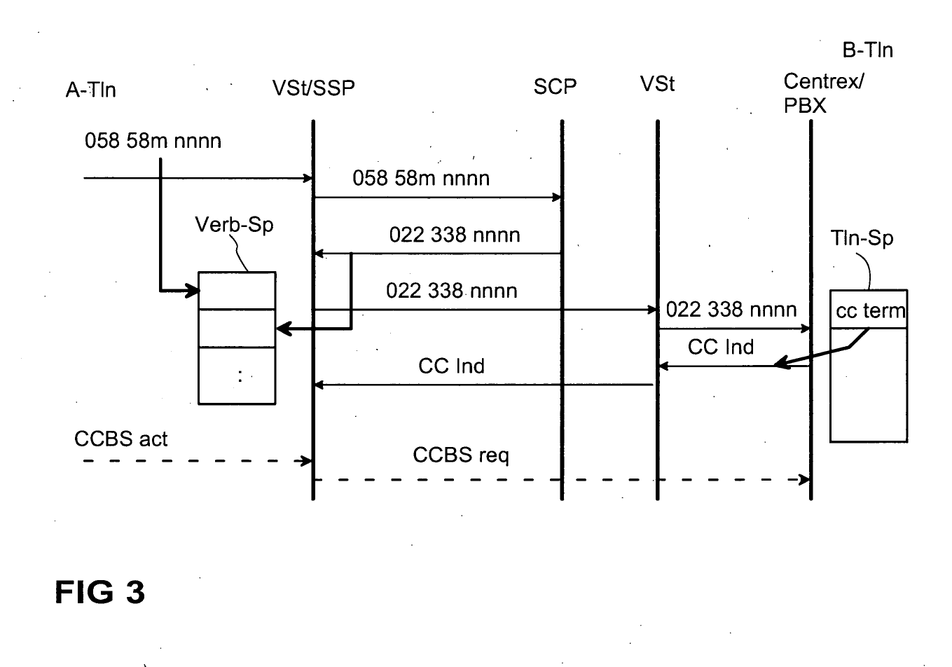

For further explanation, reference is now made to FIG. 3. In the exemplary embodiment according to the configuration shown in FIG. 1 for the Centrex scenario, an indicator, “cc term”, is provided for each subscriber, said indicator containing information as to whether said subscriber is allowed to be called by the CCBS/CCNR service. FIG. 3 does not show the whole of the message procedure but only those elements that are required for the method that is presently being explained. It is assumed that the B-subscriber called is busy or fails to reply. This is signaled back in a “RELEASE” message. According to the prior art or according to the ITU-T/ETSI standards for the protocols for setting up a call, provision is already made in this message as to whether the CCBS/CCNR service is allowed for the B-subscribers in the respective distribution point. An image of the aforementioned individual indicator specific to the B-subscriber, cc term, from the distribution point, is now filed in this message. Since the IN service “Corporate Access” forms the basis for this call, the geographical number 022 338 nn nn had previously been inserted in the Service Switching Point SSP as a result of the dialed number being 058 585 nn nn. The message from the Signaling Control Point SCP contains not only this telephone number but also further information for processing the relevant call, such as likewise, where necessary (depending on the IN Capability Set), information as to how the indicator CC Ind is to be modified in the message to the distribution point of the A-subscriber A-Tln. This further information is filed in a connection data memory Verb-Sp. In this connection data memory Verb-Sp, information relating to the modification of the indicator CC Ind is referred to as
“CC no modification”, or
“CC not possible”.

In this way it is now possible to signal to the A-subscriber the permission for an automatic return call at individual B-subscriber level whilst retaining the option of intervention, dependent on the IN service; this is done through the SCP. This permission at individual B-subscriber level can be firmly established by a Centrex administrator; it is also possible, however, for the person associated with the B-subscriber to be able to release the permission using a special sequence of symbols that can be input via the telephone keypad, for example *38#, and to block this permission using #38#.

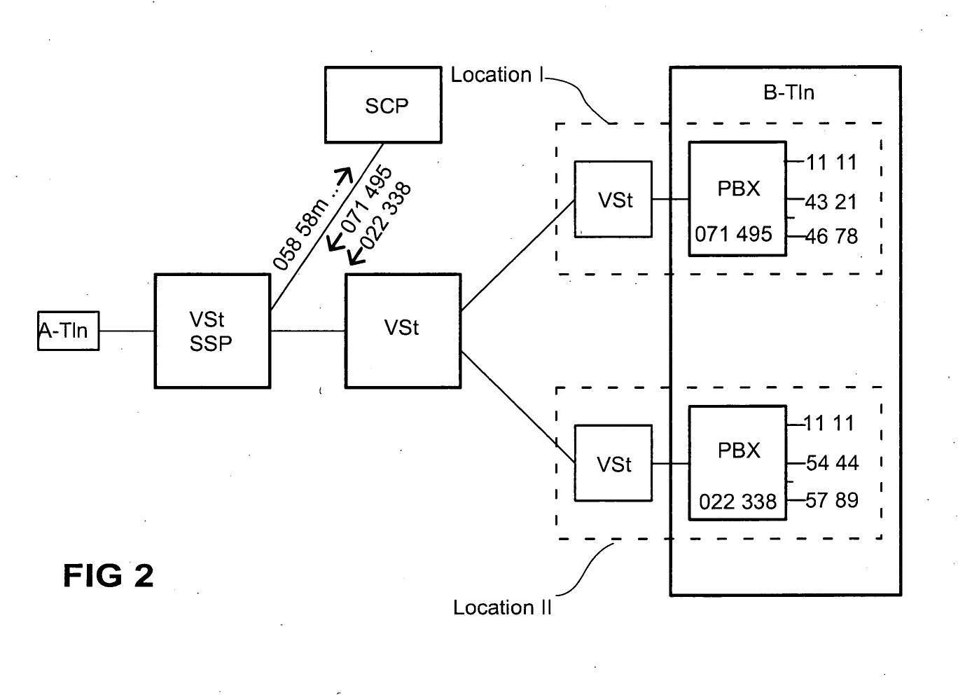

The exemplary embodiment according to FIG. 2 relates to a business whose subscribers B-Tln are connected to various private branch exchanges or PBXs. These private branch exchanges or PBXs will also generally be located in various geographical locations. This is not compulsory, however, since fairly large businesses or businesses having a vital function are provided with a plurality of private branch exchanges or PBXs at the same location for reasons of redundancy, said PBXs being furthermore connected to various distribution points Vst. Although this is not essential for the present invention, the invention can also be implemented as such for the aforementioned particular connection of the B-subscribers B-Tln. It is usual for what is referred to as an exchange to be provided for each location, location I and location II, and receive those calls where the A-subscriber A-Tln (that is, the person behind the A-subscriber A-Tln) does not know the direct dialing-in number of the B-subscriber B-Tln that is to be called. This switchboard usually has a telephone number that is easy to remember, the telephone number terminating with “11 11” or “00 00”. Likewise, it can be defined for each subscriber on the private branch exchange PBX as to whether permission has been given for an external automatic call for the relevant B-subscriber B-Tln or not. This permission is generally not given for the aforementioned switchboard. This permission is now likewise transmitted in a connection set-up message from the distribution point VSt to which the private branch exchange PBX is connected to the distribution point VSt or to the Service Switching Point SSP and, as already explained with reference to FIG. 3, filed there in the connection data memory Verb-Sp and modified if necessary. It should be noted that, in this exemplary embodiment, no switching data are filed in the distribution point VSt to which a private branch exchange is connected, with the exception of the numbering area. The numbering area uses the DDI method.

According to the configurations shown in FIGS. 1 and 2, the CCBS/CCNR service can be activated by the A-subscriber when the image of the indicator is set at “CCBS possible” in “its” distribution point, in the connection memory Verb-Sp.

In a further embodiment of the present invention provision can be made for the image of the indicator cc term to be signaled back as far as the A-subscriber itself. In this way, on a telephone with a display facility, the person in question can see whether this CCBS/CCNR service is possible for the call in question even before the CCBS/CCNR service is activated.

It would also be conceivable for the invention to be used for a non-standardized additional CC service, such as that disclosed in WO 03/036928 A1.

### LIST OF REFERENCE CHARACTERS USED

A-Tln A-subscriber
B-Tln B-subscriber
CC Ind Image of the indicator cc term in a message signaling connection set-up/release
cc term Indicator containing characteristic for allowing an automatic return call
Location I First position or first location of the distribution point VSt assigned to the private branch exchange PBX and/or of the Centrex subscriber.
Location II Second position or second location of the distribution point VSt assigned to the private branch exchange PBX and/or of the Centrex subscriber.
Tln-Sp Subscriber data memory
VSt Distribution point

### LIST OF ABBREVIATIONS AND ACRONYMS USED

CC “Automatic return call”, call completion
CCI Automatic return call containing information element possible/not possible; call completion indicator
CCBS “Automatic return call when busy”, call completion busy subscriber
CCNR “Automatic return call when no reply”, call completion no reply
DDI Direct Dialing in
In Intelligent Network
ISDN Integrated Services Digital Network
ITU International Telecommunication Union
ITU-T Telecommunication Standardization Sector of ITU
PBX Private branch exchange
PSTN Public Switched Telecommunication Network
SCP Signaling Control Point
SSP Signaling Switching Point
POTS Plain Old Telephone System

1. A method for allocating a characteristic for allowing a terminating automatic return call from an A subscriber to a B subscriber who are each connected to a switching office, comprising:
dialing the B subscriber via an IN service having number conversion;
providing the IN service by means of a Service Switching Point and a Service Control Point;
providing by the switching office for the B-subscriber an indicator at an individual level that contains information as to whether an automatic return call is allowed for the B-subscriber;
transmitting an image of the indicator to the switching office of the A-subscriber in a connection set-up/release message; and
depending on information transmitted by the Service Control Point, modifying the permission contained in the indicator for an automatic return call in the image in the Service Switching Point.

2. The method of claim 1,
wherein
the B-subscriber is connected to a Centrex group.

3. The method of claim 1,
the B-subscriber is connected to a private branch exchange (PBX).

4. The method of claim 1,
wherein
the automatic return call is implemented in a term “call completion busy subscriber”.

5. The method of claim 1,
wherein
the automatic return call is implemented in a term “call completion no reply”.
